(19) United States
(12) Patent Application Publication
(10) Pub. No.: US 2006/0203402 A1
(43) Pub. Date: Sep. 14, 2006

(54) Fireguard circuit

(76) Inventor: Victor V. Aromin, West Warwick, RI (US)

Correspondence Address: KRIEGSMAN & KRIEGSMAN, 665 Franklin Street, Framingham, MA, 01702, US

(21) Appl. No.: 11/358,909

(22) Filed: Feb. 21, 2006

Related U.S. Application Data
(63) Continuation-in-part of application No. 10/102,539, filed on Mar. 27, 2002, now Pat. No. 6,738,241.
(63) Continuation-in-part of application No. 10/783,966, filed on Feb. 20, 2004.
(63) Continuation-in-part of application No. 10/846,358, filed on May 13, 2004.
(63) Continuation-in-part of application No. 10/886,269, filed on Jul. 7, 2004.

(51) Int. Cl. H02H 9/08; H02H 3/00

(52) U.S. Cl. 361/42

(57) ABSTRACT

A fireguard circuit for a power cable, which comprises a power line, a neutral line and a metal sheath surrounding the power line and the neutral line, includes a circuit breaker switch located in one of the lines. A solenoid sets the circuit breaker switch in either an open position or a closed position. An arc detection subcircuit connects the metal sheath to the solenoid and causes the solenoid to open the circuit breaker switch upon detecting the presence of an arcing condition between either the power line and the metal sheath or the neutral line and the metal sheath. The power connections for the solenoid and the arc detection subcircuit are derived from the power cable at the power source. In order to prevent the solenoid from overheating and/or burning upon the presence of an arcing condition, a protection switch is ganged to the solenoid and terminates the supply of power to the solenoid when an arcing condition is detected.

### CROSS-REFERENCE TO RELATED APPLICATIONS

The present application is a continuation-in-part of U.S. Pat. No. 6,738,241 which issued in the name of Victor V. Aromin on May 18, 2004, U.S. patent application Ser. No. 10/783,966 which was filed on Feb. 20, 2004 in the name of Victor V. Aromin, U.S. patent application Ser. No. 10/846,358 which was filed on May 13, 2004 in the name of Victor V. Aromin, and U.S. patent application Ser. No. 10/886,269 which was filed on Jul. 7, 2004 in the name of Victor V. Aromin, the disclosures of all being incorporated herein by reference.

### BACKGROUND OF THE INVENTION

The present invention relates generally to electrical safety devices and more particularly to electrical safety devices for a power cable.

Conventional electrical appliances typically receive alternating current (AC) power from a power source, such as an electrical outlet, through a power cable. The power cable enables the electrical appliance, or load, to receive from the power source the current necessary to operate.

A power cable typically comprises at least two conducting lines through which current travels from the power source to the load. Specifically, a power cable typically comprises a power line and a neutral line. A metal sheath can be used to surround the power line and the neutral line in order to provide the power cable with arc sensing capabilities.

The connection of an electrical appliance to a power supply through a pair of conducting lines can create a number of potentially dangerous conditions. In particular, there exists the risk of ground fault and grounded neutral conditions in the conducting lines. A ground fault condition occurs when there is an imbalance between the currents flowing in the power and neutral lines. A grounded neutral condition occurs when the neutral line is grounded at the load.

Ground fault circuit interrupters are well known in the art and are commonly used to protect against ground fault and grounded neutral conditions. A ground fault circuit interrupter (GFCI) typically comprises a differential transformer with opposed primary windings, one primary winding being associated with the power line and the other primary winding being associated with the neutral line. If a ground fault condition should occur on the load side of the GFCI, the two primary windings will no longer cancel, thereby producing a flux flow in the core of the differential transformer. This resultant flux flow is detected by a secondary winding wrapped around the differential transformer core. In response thereto, the secondary winding produces a trip signal which, in turn, serves to open at least one of the conducting lines between the power supply and the load, thereby eliminating the dangerous condition.

As an example, in U.S. Pat. No. 5,757,598, to V. V. Aromin, there is disclosed a ground fault circuit interrupter (GFCI) which interrupts the flow of current through a pair of lines extending between a source of power and a load. The GFCI includes a circuit breaker having a switch located in one of the pair of the lines. The switch has a first position in which the source of power in its associated line is not connected to the load and a second position in which the source of power in its associated line is connected to the load. A relay circuit is coupled to the switch for selectively positioning the switch in either the first or second position. The relay circuit includes a solenoid which operates in either an energized or a de-energized state. When energized, the solenoid positions the switch in its second position and when de-energized, the solenoid positions the switch in its first position. The GFCI also includes a booster circuit for selectively supplying a first voltage through the switch and to the solenoid which is sufficient to cause the solenoid to switch from its de-energized state to its energized state. A power supply circuit supplies a second voltage to the solenoid which is less than the first voltage. The second voltage is sufficient to maintain the solenoid in its energized state after being initially energized by the first voltage but is insufficient to switch the solenoid from its de-energized state to its energized state. A latch circuit operable in first and second bi-stable states allows the solenoid to switch from its de-energized state to its energized state and remain in its energized state when in its first bi-stable state and allowing solenoid to switch from its energized state to its de-energized state and remain in its de-energized state when in its second bi-stable state. A fault detection circuit detects the presence of a fault condition in at least one of the lines extending between the power and the load and causes the latch circuit to latch in its second bi-stable state upon detection of the fault condition.

While GFCI circuits of the type described above are well known and widely used in commerce to protect against ground fault and grounded neutral conditions, it should be noted that a power cable is susceptible to other types of hazardous conditions which are not protected against by a conventional GFCI circuit.

As an example, it has been found that one type of arcing condition can occur between one of the conducting lines and the metal sheath which surrounds the conducting lines. It should be noted that the presence of this type of arcing condition between either the power line and the metal sheath or the neutral line and the metal sheath can result in a fire or other dangerous condition, which is highly undesirable.

Accordingly, in U.S. Pat. No. 4,931,894 to R. Legatti, there is disclosed a ground fault current interrupter circuit (GFCI) which is provided with the additional capacity of detecting and protecting against arcing between a power line and the metal sheath or cover of a power cable. An arc protection winding is located on the core of the GFCI differential transformer and is connected in series with a resistance between the metal sheath and a neutral or return line. By adjusting the number of turns of the arc protection winding and the size of the series resistance, the sensitivity of the arc protection arrangement to arcing current may be set at a desired level.

Although well known in commerce, the GFCI disclosed in Legatti suffers from a notable drawback. Specifically, the GFCI disclosed in Legatti requires a differential transformer in order to detect arcing conditions between the power line and the metal sheath or the neutral line and the metal sheath. As can be appreciated, the implementation of a differential transformer significantly increases the overall size and cost of the product, which is highly undesirable.

### SUMMARY OF THE INVENTION

It is an object of the present invention to provide a new and improved safety circuit for a power cable which includes two or more conducting lines and a metal sheath surrounding the conducting lines.

It is another object of the present invention to provide a safety circuit as described above which senses the presence of an arcing condition between one of the conducting lines and the metal sheath, and in response thereto, opens at least one of the conducting lines between the power supply and the load.

It is yet another object of the present invention to provide a safety circuit as described above which may be mass produced, has a minimal number of parts, and can be easily assembled.

Accordingly, in one embodiment of the present invention, there is provided a fireguard circuit for use with a power cable, the power cable connecting a power source with a load, the power cable comprising a power line, a neutral line and a metal sheath which surrounds the power line and the neutral line, the fireguard circuit comprising (a) a circuit breaker comprising a circuit breaker switch located in one of the lines between the power source and the load, the circuit breaker switch having a first position in which the power source in its associated line is connected to the load and a second position in which the power source in its associated line is not connected to the load, (b) a circuit opening device for setting the circuit breaker switch in either its first position or its second position, the circuit opening device being operable in either a first state or a second state, the circuit opening device setting the circuit breaker switch in its first position when in its first state and the circuit opening device setting the circuit breaker switch in its second position when in its second state, (c) an arc detection subcircuit connecting the metal sheath to the circuit opening device, the arc detection subcircuit setting the circuit opening device in its second state upon detecting the presence of an arcing condition between either of the lines and the metal sheath, and (d) a protection switch for terminating the supply of power to the circuit opening device when the circuit opening device is in its second state.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration specific embodiments for practicing the invention. These embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a schematic circuit diagram of a first embodiment of a fireguard circuit constructed according to the teachings of the present invention;

FIG. 2 is a schematic circuit diagram of a second embodiment of a fireguard circuit constructed according to the teachings of the present invention;

FIG. 3 is a schematic circuit diagram of a third embodiment of a fireguard circuit constructed according to the teachings of the present invention;

FIG. 4 is a schematic circuit diagram of a fourth embodiment of a fireguard circuit constructed according to the teachings of the present invention;

FIG. 5 is a schematic circuit diagram of a fifth embodiment of a fireguard circuit constructed according to the teachings of the present invention;

FIG. 6 is a schematic circuit diagram of a sixth embodiment of a fireguard circuit constructed according to the teachings of the present invention; and

FIG. 7 is a schematic circuit diagram of a seventh embodiment of a fireguard circuit constructed according to the teachings of the present invention.

### DETAILED DESCRIPTION OF PREFERRED EMBODIMENTS

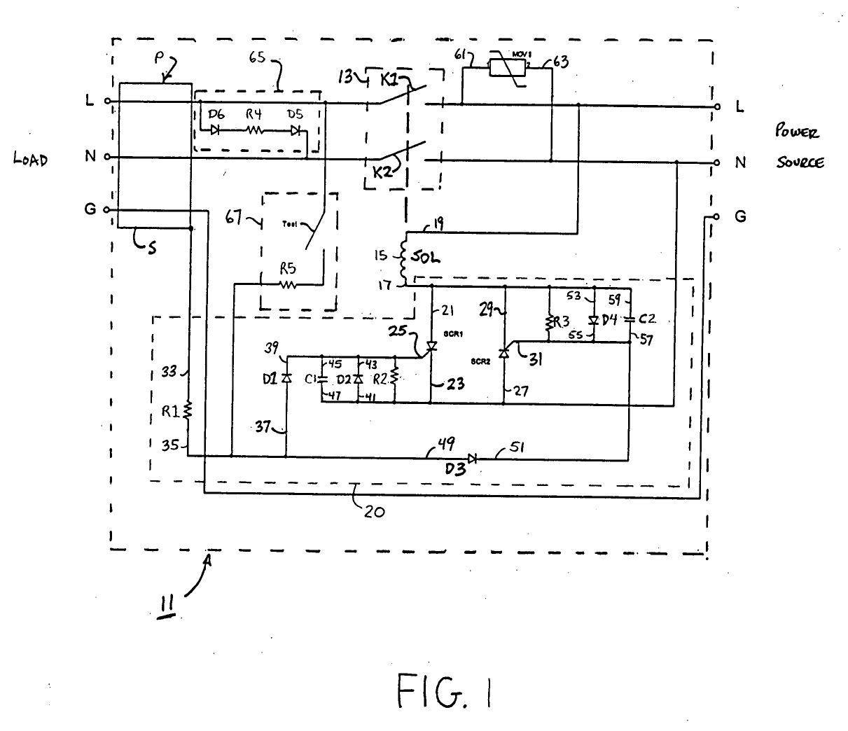

Referring now to FIG. 1, there is shown a first embodiment of a fireguard circuit constructed according to the teachings of the present invention, the fireguard circuit being represented generally by reference numeral 11. Fireguard circuit 11 is designed principally for use as a safety device for a power cable P which connects a power source (i.e., a line) to a load, said power cable P including a power line L, a neutral line N and a ground line G. Each of the power and neutral lines L and N is wrapped with a metal sheath or other similar type of shielded wrapping. The metal sheaths of the power and neutral lines L and N are, in turn, twisted together so as to effectively form a single metal sheath S which surrounds power line L and neutral line N. Ground line G remains electrically isolated from power line L and neutral line N.

As will be discussed in detail below, fireguard circuit 11 interrupts the flow of current through power line L and neutral line N extending between the power source and the load when an arcing condition occurs either (i) between power line L and metal sheath S or (ii) between neutral line N and metal sheath S. As can be appreciated, the presence of an arcing condition either between power line L and metal sheath S or between neutral line N and metal sheath S can result in a fire or other dangerous condition, which is highly undesirable.

Fireguard circuit 11 (which is also referred to herein as safety circuit 11) comprises a circuit breaker 13 which selectively opens and closes power line L and neutral line N. Circuit breaker 13 includes a first normally-closed switch K1 which is located in power line L between the power source and the load. Circuit breaker 13 also includes a second normally-closed switch K2 which is located in neutral line N between the power source and the load.

Switches K1 and K2 can be positioned in either of two connective positions. Specifically, switches K1 and K2 can be positioned in either a first, or closed, position or a second, or open, position. With switches K1 and K2 disposed in their closed position, which is the opposite position as illustrated in FIG. 1, current is able to flow from the power source to the load. With switches K1 and K2 disposed in their open position, which is illustrated in FIG. 1, current is unable to flow from the power source to the load.

A circuit opening device, represented herein as solenoid SOL, is ganged to the circuit breaker contacts of switches K1 and K2 and is responsible for selectively controlling the connective position of switches K1 and K2. Specifically, when solenoid SOL is de-energized, switches K1 and K2 remain in their closed positions. However, when solenoid SOL is energized, solenoid SOL moves and maintains switches K1 and K2 into their open positions. Solenoid SOL includes a winding 15 which includes a first end 17 and a second end 19, second end 19 being connected to power line L.

It should be noted that fireguard circuit 11 is not limited to the use of solenoid SOL to selectively move and maintain the connective position of switches K1 and K2. Rather, it is to be understood that solenoid SOL could be replaced with alternative types of circuit opening devices which are well known in the art without departing from the spirit of the present invention.

Fireguard circuit 11 additionally includes an arc detection subcircuit 20 which connects metal sheath S to solenoid SOL. As will be described in detail below, subcircuit 20 functions by (1) detecting the presence of an arcing condition either between the power line L and the metal sheath S or between the neutral line N and the metal sheath S and (2) in response to the detection of either arcing condition, energizing solenoid SOL which, in turn, opens circuit breaker 13, thereby eliminating the arcing condition. The details of subcircuit 20 will be described in detail herein.

Specifically, subcircuit 20 comprises a first silicon controlled rectifier SCR1 which acts to detect the presence of an arcing condition between the power line L and the metal sheath S and to switch solenoid SOL from its de-energized state to its energized state upon detecting the presence of the arcing condition between the power line L and the metal sheath S. First silicon controlled rectifier SCR1 preferably has a model number of EC103B and includes an anode 21, a cathode 23 and a gate 25. Anode 21 of first silicon controlled rectifier SCR1 is connected to first end 17 of winding 15.

Subcircuit 20 also comprises a second silicon controlled rectifier SCR2 which acts to detect the presence of an arcing condition between the neutral line N and the metal sheath S and to switch solenoid SOL from its de-energized state to its energized state upon detecting the presence of the arcing condition between the neutral line N and the metal sheath S. Second silicon controlled rectifier SCR2 preferably has a model number of EC103B and includes an anode 27, a cathode 29 and a gate 31. Anode 27 of second silicon controlled rectifier SCR2 is connected to cathode 23 of first silicon controlled rectifier SCR1. Cathode 29 of second silicon controlled rectifier SCR2 is connected to anode 21 of first silicon controlled rectifier SCR1.

It should be noted that the inclusion and particular connection of rectifiers SCR1 and SCR2 serves as a feature of the present invention. Specifically, first rectifier SCR1 is disposed in parallel with second rectifier SCR2, with first rectifier SCR1 being disposed in the opposite direction from second rectifier SCR2. Due to the opposite polarities of rectifiers SCR1 and SCR2, only first SCR1 will energize solenoid SOL upon the presence of an arcing condition between hot line L and metal sheath S. Similarly, due to the opposite polarities of rectifiers SCR1 and SCR2, only second rectifier SCR2 will energize solenoid SOL upon the presence of an arcing condition between neutral line N and metal sheath S. As such, with alternating current (AC) power traveling through power cable P, first rectifier SCR1 serves to monitor the positive half of the current cycle and second rectifier SCR2 serves to monitor the negative half of the current cycle, as will be described further below.

A voltage dropping resistor R1 has a value of approximately 15 Kohms and includes a first terminal 33 and a second terminal 35. First terminal 33 of resistor R1 is connected to metal sheath S. Accordingly, the presence of an arcing condition between either power line L and metal sheath S or neutral line N and metal sheath S creates a current leakage which travels through resistor R1. As such, resistor R1 serves to drop the current leakage voltage to an acceptable level before said current leakage voltage is passed onto first and second rectifiers SCR1 and SCR2.

A first isolation diode D1 serves to isolate the gate connection of first rectifier SCR1 for reverse transients. First isolation diode D1 preferably has a model number of IN4004 and includes an anode 37 and a cathode 39. Anode 37 of first isolation diode D1 is connected to second terminal 35 of resistor R1. Cathode 39 of first isolation diode D1 is connected to gate 25 of first rectifier SCR1.

A first protection diode D2 serves to protect the gate connection of first rectifier SCR1 from an overvoltage, or shunt, condition. First protection diode D2 preferably has a model number of IN4148 and includes an anode 41 and a cathode 43. Anode 41 of first protection diode D2 is connected to cathode 23 of first rectifier SCR1. Cathode 43 of first protection diode D2 is connected to gate 25 of first rectifier SCR1.

A first capacitor C1 serves to filter out high frequency noise from passing onto the gate connection of first rectifier SCR1. First capacitor C1 preferably has a value of approximately 0.22 uF and includes a first terminal 45 and a second terminal 47. First terminal 45 of first capacitor C1 is connected to gate 25 of first rectifier SCR1. Second terminal 47 of first capacitor C1 is connected to cathode 23 of first rectifier SCR1.

A nuisance tripping resistor R2 serves to reduce the likelihood of nuisance tripping in rectifier SCR1. Nuisance tripping resistor R2 preferably has a value of 330 ohms and is connected in parallel with capacitor C1 and protection diode D2, with one of its terminals connected to gate 25 of first rectifier SCR1 and the other of its terminals connected to cathode 23 of first rectifier SCR1.

A second isolation diode D3 serves to isolate the gate connection of second rectifier SCR2 for reverse transients. Second isolation diode D3 preferably has a model number of IN4004 and includes an anode 49 and a cathode 51. Anode 49 of second isolation diode D3 is connected to second terminal 35 of resistor R1. Cathode 51 of second isolation diode D3 is connected to gate 31 of second rectifier SCR2.

A second protection diode D4 serves to protect the gate connection of second rectifier SCR2 from an overvoltage, or shunt, condition. Second protection diode D4 preferably has a model number of IN4148 and includes an anode 53 and a cathode 55. Anode 53 of second protection diode D4 is connected to first end 17 of winding 15. Cathode 55 of second protection diode D4 is connected to gate 31 of second rectifier SCR2.

A second capacitor C2 serves to filter out high frequency noise from passing onto the gate connection of second rectifier SCR2. Second capacitor C2 preferably has a value of approximately 0.22 uF and includes a first terminal 57 and a second terminal 59. First terminal 57 of second capacitor C2 is connected to gate 31 of second rectifier SCR2. Second terminal 59 of second capacitor C2 is connected to first end 17 of winding 15.

A nuisance tripping resistor R3 serves to reduce the likelihood of nuisance tripping in rectifier SCR2. Nuisance tripping resistor R3 preferably has a value of 330 ohms and is connected in parallel with capacitor C2 and protection diode D4, with one of its terminals connected to gate 31 of second rectifier SCR2 and the other of its terminals connected to first end 17 of winding 15.

Fireguard circuit 11 also includes a metal-oxide varistor MOV1 to protect against voltage surges in power and neutral conducting lines L and H. Metal-oxide varistor MOV1 preferably has a model number of Z151 and includes a first terminal 61 and a second terminal 63. First terminal 61 of metal-oxide varistor MOV1 is connected to power line L and second terminal 63 of metal-oxide varistor MOV1 is connected to neutral line N.

Fireguard circuit 11 additionally includes an indicator circuit 65, indicator circuit 65 connecting power line L to neutral line N at a location between sheath S and circuit breaker 13. Indicator circuit 65 comprises a light emitting diode (LED) D5, a current limiting resistor R4 and a protection diode D6 which are connected in series. Preferably, current limiting resistor R4 has a value of approximately 33 Kohms and protection diode D6 has a model number of 1N4004. In use, indicator circuit 65 serves to provide a visual indication (i.e., a light) when power is being applied to the load.

Fireguard circuit 11 further includes a test circuit 67, test circuit 67 connecting power line L (at a location between sheath S and circuit breaker 13) to terminal 35 of voltage dropping resistor R1. Test circuit 67 comprises a test switch TEST and a resistor R5 which are connected in series. Preferably, resistor R5 has a value of approximately 33 Kohms. In use, test circuit 67 allows the user to test whether fireguard circuit 11 is operating properly.

In use, fireguard switch 11 functions in the following manner. In the absence of arcing conditions, switches K1 and K2 are disposed in their normally-closed positions, thereby enabling AC power to pass from the power source to the load through power and neutral lines L and N. With switches K1 and K2 closed, light emitting diode D5 of indicator circuit 65 illuminates to visually indicate to the user that power is being applied to the load.

Upon the presence of an arcing condition between power line L and metal sheath S, leakage voltage travels from metal sheath S and passes through resistor R1, resistor R1 dropping the leakage voltage to an acceptable level. The reduced leakage voltage travels through both isolation diodes D1 and D3. However, due to the opposite polarities of rectifiers SCR1 and SCR2, the reduced leakage voltage only triggers gate 25 of first rectifier SCR1 and does not trigger gate 31 of second rectifier SCR2. Specifically, the reduced leakage voltage only triggers gate 25 of rectifier SCR1 because the signal at gate 25 is opposite in potential with respect to the polarity of cathode 23. The triggering of gate 25 causes first rectifier SCR1 to conduct which, in turn, energizes solenoid SOL. Once energized, solenoid SOL opens switches K1 and K2 which, in turn, serves to eliminate the arcing condition, which is highly desirable.

Upon the presence of an arcing condition between neutral line L and metal sheath S, leakage voltage travels from metal sheath S and passes through resistor R1, resistor R1 dropping the leakage voltage to an acceptable level. The reduced leakage voltage travels through both isolation diodes D1 and D3. However, due to the opposite polarities of rectifiers SCR1 and SCR2, the reduced leakage voltage only triggers gate 31 of second rectifier SCR2 and does not trigger gate 25 of first rectifier SCR1. Specifically, the reduced leakage voltage only triggers gate 31 of rectifier SCR2 because the signal at gate 31 is opposite in potential with respect to the polarity of cathode 29. The triggering of gate 31 causes second rectifier SCR2 to conduct which, in turn, energizes solenoid SOL. Once energized, solenoid SOL opens switches K1 and K2 which, in turn, serves to eliminate the arcing condition, which is highly desirable.

It should be noted that fireguard circuit 11 differs from conventional electrical safety devices in that subcircuit 20 of fireguard circuit 11 includes a pair of opposite polarity silicon controlled rectifiers which are disposed in parallel for sensing the presence of an arcing condition (rather than a differential transformer as in most conventional fireguard circuits). The fact that fireguard circuit 11 utilizes a pair of silicon controlled rectifiers rather than a differential transformer renders fireguard circuit 11 more compact in size and less expensive to manufacture than conventional electrical safety devices which utilize a differential transformer, which is highly desirable.

It should also be noted that fireguard circuit 11 differs from conventional electrical safety devices in that fireguard circuit 11 is symmetrical and non-polarized in its design. As a result, fireguard circuit 11 would continue to operate effectively even if it were connected in reverse (i.e., turned upside down), which is highly desirable. In other words, the connections to power line L and neutral line N of fireguard circuit 11 could be reversed without compromising the functionality of fireguard circuit 11.

It should further be noted that although fireguard circuit 11 is shown for use as a safety device for a power cable which comprises three conducting lines, it is to be understood that fireguard circuit 11 could also be used as a safety device for a power cable which comprises two conducting lines (i.e., without ground line G) without departing from the spirit of the present invention.

It should additionally be noted that although fireguard circuit 11 is represented herein as being in the form of a 120 volt version of a protection circuit, fireguard circuit 11 could be implemented as a 240 volt version of a protection circuit without departing from the spirit of the present invention.

Although useful in protecting against arcing conditions, fireguard circuit 111 suffers from one notable drawback. Specifically, because solenoid SOL is powered from the line side (i.e., by the power source), solenoid SOL is susceptible to overheating and/or burning upon the presence of an arcing condition (e.g., when metal sheath S is shorted to ground G), which is highly undesirable.

Accordingly, each of the fireguard circuits to be described in detail below is provided with a protection switch K3 which terminates the supply of power to solenoid SOL from power line L when an arcing condition is detected in order to prevent solenoid SOL from overheating and/or burning. It is to be understood that the inclusion of protection switch K3 in each fireguard circuit serves as the principal novel feature of the present invention.

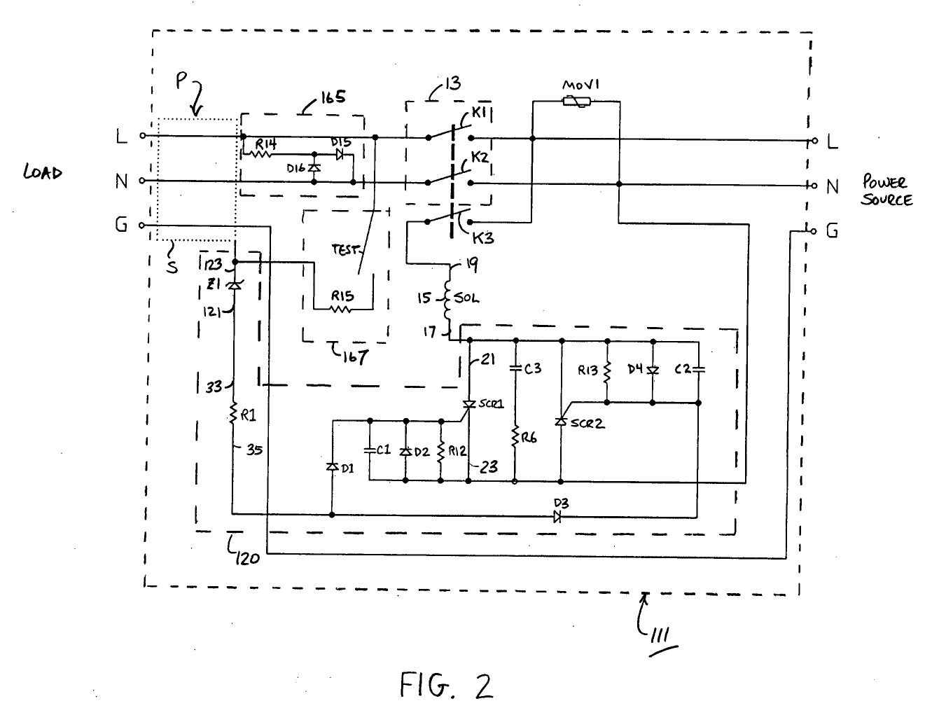

Specifically, referring now FIG. 2, there is shown a second embodiment of a fireguard circuit constructed according to the teachings of the present invention, the fireguard circuit being represented generally by reference numeral 111.

Fireguard circuit 111 (which may also be referred to herein as safety circuit 111) is identical in all respects with fireguard circuit 11 with four notable distinctions, as will be enumerated below.

As the first and primary distinction from fireguard circuit 11, fireguard circuit 111 additionally includes a third normally-closed switch K3 (also referred to herein as protection switch K3) which is located in the line which connects second end 19 of winding 15 to the power line L. Solenoid SOL is ganged to third normally-closed switch K3. As a result, solenoid SOL is responsible for selectively controlling the connective position of switches K1, K2 and K3. Specifically, when solenoid SOL is de-energized, switches K1, K2 and K3 remain in their closed positions. However, when solenoid SOL is energized, solenoid SOL moves and maintains switches K1, K2 and K3 into their open positions. In this manner, it is to be understood that the function of switch K3 is to prevent solenoid SOL from overheating and/or burning during an arcing condition (e.g., as a result of a shorting metal sheath S) by opening the supply of power to solenoid SOL from power line L.

As a second distinction from fireguard circuit 11, fireguard circuit 111 comprises an arc detection subcircuit 120 that differs in construction from subcircuit 20 in fireguard circuit 11 in the following ways: (1) subcircuit 120 additionally includes a capacitor C3 and a resistor R6 which are connected in series, one end of which is connected to anode 21 of first silicon controlled rectifier SCR1 and the other end of which is connected to cathode 23 of first silicon controlled rectifier SCR1. Capacitor C3 preferably has a value of 0.01 uF and resistor R6 preferably has a value of 1.0 Kohms. Together, capacitor C3 and resistor R6 ensure that fireguard circuit 111 is compliant with UL performance tests for unwanted tripping (i.e., ring wave) and surging in accordance with UL Standard 1699; (2) the preferred values of selected components in subcircuit 20 are modified slightly in fireguard circuit 111. Specifically, resistors R2 and R3 in subcircuit 20 are replaced with resistors R12 and R13 in subcircuit 120, each of resistors R12 and R13 having a value of approximately 680 ohms; and (3) subcircuit 120 additionally includes a zener diode Z1 connected in series between sheath S1 and voltage dropping resistor R1. Zener diode Z1 preferably has a model number of 1N5266 and includes an anode 121 connected to voltage dropping resistor R1 and a cathode 123 connected to sheath S. In use, zener diode Z1 is connected in series between with sheath S and first and second silicon controlled rectifiers SCR1 and SCR2 in order to reduce the peak voltage applied to metal sheath (i.e., to reduce shield bias).

As a third distinction from fireguard circuit 11, fireguard circuit 111 includes an indicator circuit 165 (connecting power line L to neutral line N at a location between sheath S and circuit breaker 13) which differs slightly in construction from indicator circuit 65 in fireguard circuit 11. Specifically, indicator circuit 165 comprises a light emitting diode (LED) D15, a current limiting resistor R14 and a protection diode D16, with LED D15 and resistor R14 connected in series between power line L and neutral line N and with protection diode D16 connected in parallel with LED D15 (in reverse polarity). Preferably, current limiting resistor R14 has a value of 68 Kohms and protection diode D16 has a model number of 1N4148. In use, indicator circuit 165 serves to provide a visual indication (i.e., a light) when power is being applied to the output of fireguard circuit 111 (i.e., the load).

As a fourth distinction from fireguard circuit 11, fireguard circuit 111 includes a test circuit 167 which differs slightly from test circuit 67 in fireguard circuit 11 in both its component values and its connection to the remainder of fireguard circuit 111. Specifically, test circuit 167 is connected, at one end, to power line L at a location between sheath S and circuit breaker 13 and, at the other end, directly to sheath S. Test circuit 167 comprises a test switch TEST and a resistor R15 which are connected in series. Preferably, resistor R15 has a value of approximately 15 Kohms. In use, test circuit 167 allows the user to test whether fireguard circuit 111 is operating properly.

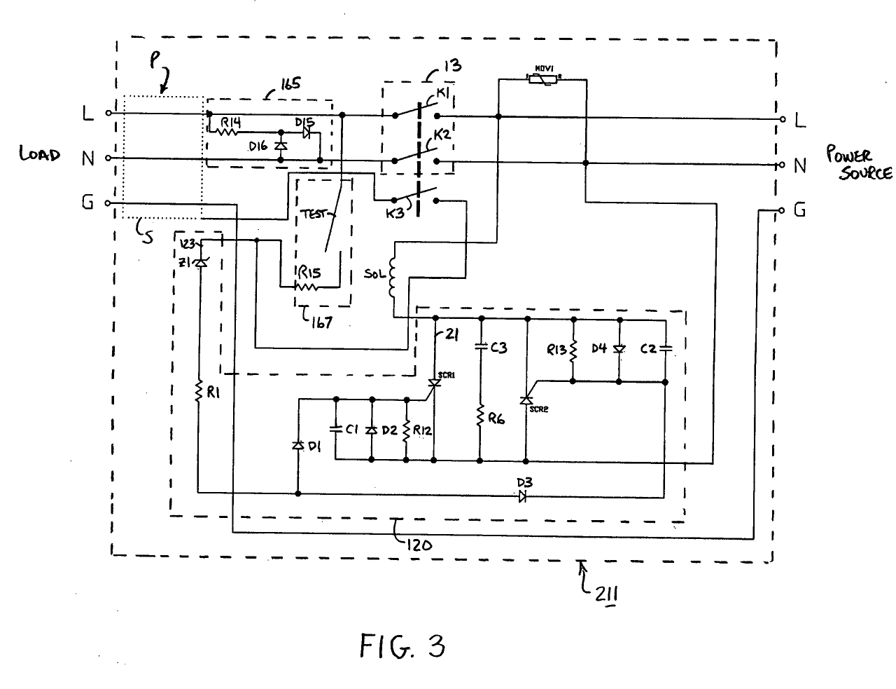

Referring now FIG. 3, there is shown a third embodiment of a fireguard circuit constructed according to the teachings of the present invention, the fireguard circuit being represented generally by reference numeral 211.

Fireguard circuit 211 is identical in all respects with fireguard circuit 111 with one notable exception: the location of protection switch K3. Specifically, as can be seen in FIG. 3, protection switch K3 is relocated in the line which connects metal sheath S to the input of arc detection subcircuit 120 (i.e., cathode 123 of zener diode Z1). As a result, solenoid SOL connects the output of arc detecetion subcircuit 120 (i.e., anode 21 of first silicon controlled rectifier SCR1) with power line L (as in fireguard circuit 11).

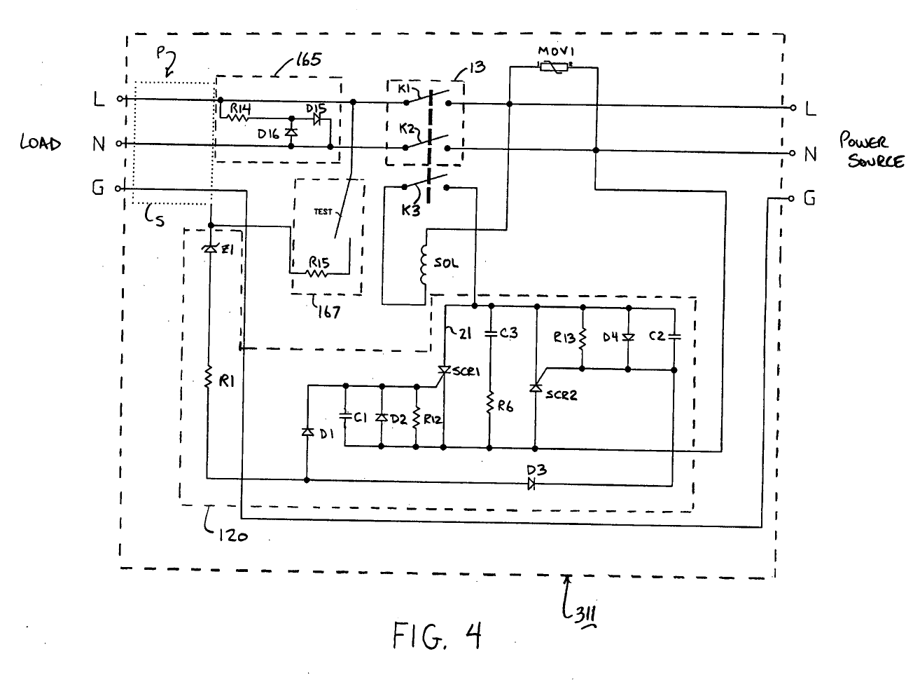

Referring now FIG. 4, there is shown a fourth embodiment of a fireguard circuit constructed according to the teachings of the present invention, the fireguard circuit being represented generally by reference numeral 311.

Fireguard circuit 311 is identical in all respects with fireguard circuit 111 with one notable exception: the location of protection switch K3. Specifically, as can be seen in FIG. 4, protection switch K3 is relocated in the line which connects the output of arc detection subcircuit 120 (i.e., anode 21 of first silicon controlled rectifier SCR1) to solenoid SOL.

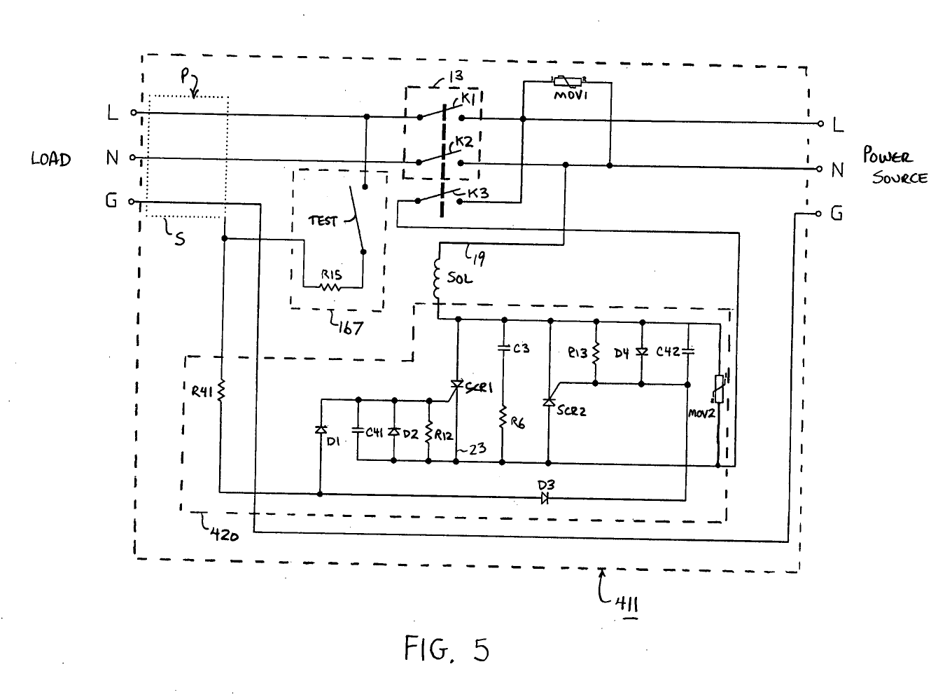

Referring now to FIG. 5, there is shown a fifth embodiment of a fireguard circuit constructed according to the teachings of the present invention, the fireguard circuit being represented generally by reference numeral 411. It should be understood that the particular construction of fireguard circuit 411 may serve as the basis for the manufacture of a cordless, 120 volt model leakage-current and detection interruption (LCDI) device.

Fireguard circuit 411 (which may also be referred to herein as safety circuit 411) is identical in all respects with fireguard circuit 111 with four notable distinctions, as will be enumerated below.

As a first distinction from fireguard circuit 111, fireguard circuit 411 comprises an arc detection subcircuit 420 that differs in construction from subcircuit 120 in fireguard circuit 111 in the following ways: (1) subcircuit 420 additionally includes an optional second metal-oxide varistor MOV2 which is connected in parallel with capacitor C3 and a resistor R6; (2) the preferred values of selected components in subcircuit 120 are modified slightly in fireguard circuit 411. Specifically, resistor R1 in subcircuit 120 is replaced with a resistor R41 in subcircuit 420, resistor R41 having a value of approximately 68 Kohms. In addition, capacitors C1 and C2 in subcircuit 120 are replaced with capacitors C41 and C42, respectively, each of capacitors C41 and C42 having a value of approximately 0.68 uF; and (3) subcircuit 420 does not include zener diode Z1.

As a second distinction from fireguard circuit 111, arc detection subcircuit 420 (in particular, cathode 23 of first silicon controlled rectifier SCR1) is connected to power line L (as opposed to neutral line N as in fireguard circuit 111) and second end 19 of solenoid SOL is connected to neutral line N (as opposed to power line L in fireguard circuit 111).

As a third distinction from fireguard circuit 111, fireguard circuit 411 relocates the placement of protection switch K3. Specifically, as can be seen in FIG. 5, protection switch K3 is relocated in the line which connects arc detection subcircuit 420 (i.e., cathode 23 of first rectifier SCR1) to power line L. Accordingly, solenoid SOL connects the output of arc detection subcircuit 420 with neutral line N.

As a fourth distinction from fireguard circuit 111, fireguard circuit 411 does not include indicator circuit 165 (connecting power line L to neutral line N at a location between sheath S and circuit breaker 13).

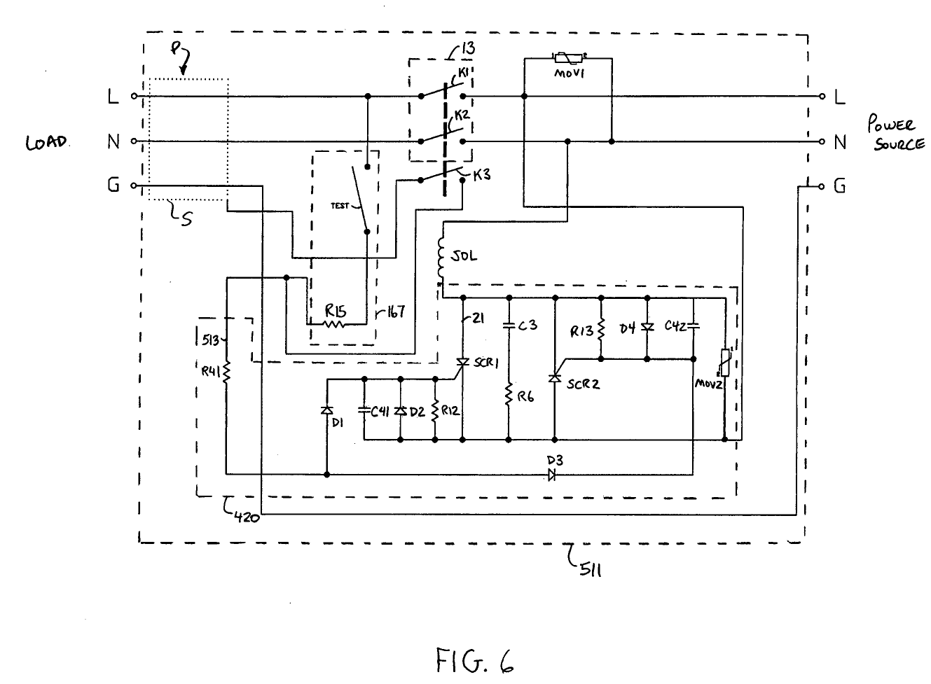

Referring now FIG. 6, there is shown a sixth embodiment of a fireguard circuit constructed according to the teachings of the present invention, the fireguard circuit being represented generally by reference numeral 511.

Fireguard circuit 511 is identical in all respects with fireguard circuit 411 with one notable exception: the location of protection switch K3. Specifically, as can be seen in FIG. 6, protection switch K3 is relocated in the line which connects metal sheath S to the input of arc detection subcircuit 420 (i.e., terminal 513 of resistor R41). As a result, solenoid SOL connects the output of arc detecetion subcircuit 120 (i.e., anode 21 of first silicon controlled rectifier SCR1) with neutral line N.

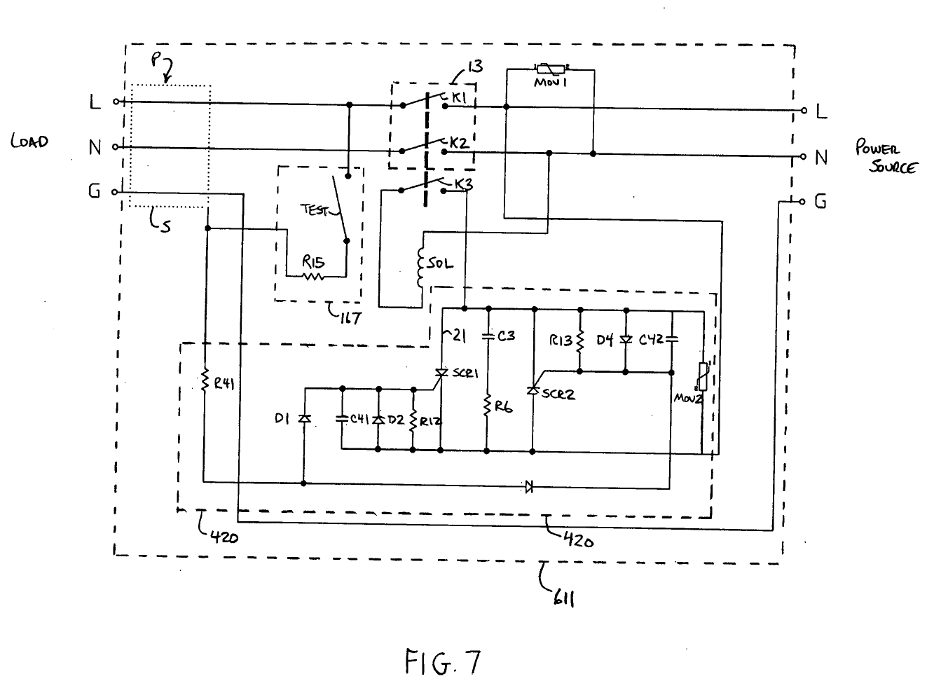

Referring now FIG. 7, there is shown a seventh embodiment of a fireguard circuit constructed according to the teachings of the present invention, the fireguard circuit being represented generally by reference numeral 611.

Fireguard circuit 611 is identical in all respects with fireguard circuit 511 with one notable exception: the location of protection switch K3. Specifically, as can be seen in FIG. 7, protection switch K3 is relocated in the line which connects the output of arc detection subcircuit 420 (i.e., anode 21 of first silicon controlled rectifier SCR1) to solenoid SOL.

The versions of the present invention described above are intended to be merely exemplary and those skilled in the art shall be able to make numerous variations and modifications to it without departing from the spirit of the present invention. For example, although the majority of the fireguard circuits described in detail above are shown for use as a safety device for a power cable which comprises three conducting lines, it is to be understood that these fireguard circuits could also be used as a safety device for a power cable which comprises two conducting lines without departing from the spirit of the present invention. All such variations and modifications are intended to be within the scope of the present invention as defined in the appended claims. For example, it should be noted that the particular components which make up the aforementioned embodiments may be interchanged or combined to form additional embodiments.

What is claimed is:

1. A fireguard circuit for use with a power cable, the power cable connecting a power source with a load, the power cable comprising a power line, a neutral line and a metal sheath which surrounds the power line and the neutral line, the fireguard circuit comprising:
(a) a circuit breaker comprising a circuit breaker switch located in one of the lines between the power source and the load, the circuit breaker switch having a first position in which the power source in its associated line is connected to the load and a second position in which the power source in its associated line is not connected to the load,
(b) a circuit opening device for setting the circuit breaker switch in either its first position or its second position, the circuit opening device being operable in either a first state or a second state, the circuit opening device setting the circuit breaker switch in its first position when in its first state and the circuit opening device setting the circuit breaker switch in its second position when in its second state,
(c) an arc detection subcircuit connecting the metal sheath to the circuit opening device, the arc detection subcircuit setting the circuit opening device in its second state upon detecting the presence of an arcing condition between either of the lines and the metal sheath, and
(d) a protection switch for terminating the supply ofpower to the circuit opening device when the circuit opening device is in its second state.

2. The fireguard circuit as claimed in claim 1 wherein the power connections for the circuit opening device and the arc detection subcircuit are derived from the power cable at the power source.

3. The fireguard circuit as claimed in claim 2 wherein the circuit opening device is ganged to both the circuit breaker switch and the protection switch.

4. The fireguard circuit as claimed in claim 1 wherein the circuit opening device connects the arc detection subcircuit to the power line.

5. The fireguard circuit as claimed in claim 4 wherein the protection switch is located in the line which connects the circuit opening device to the power line.

6. The fireguard circuit as claimed in claim 1 wherein the arc detection subcircuit is connected to the power line.

7. The fireguard circuit as claimed in claim 6 wherein the protection switch is located in the line which connects the arc detection subcircuit to the power line.

8. The fireguard circuit as claimed in claim 1 wherein the protection switch is located in the line which connects the metal sheath to the arc detection subcircuit.

9. The fireguard circuit as claimed in claim 1 wherein the protection switch is located in the line which connects the arc detection subcircuit to the circuit opening device.

10. The fireguard circuit as claimed in claim 1 wherein the arc detection subcircuit comprises a first silicon controlled rectifier (SCR) for detecting the presence of an arcing condition between one of the lines and the metal sheath, the first SCR setting the circuit opening device at its second state upon detecting the presence of an arcing condition between one of the lines and the metal sheath.

11. The fireguard circuit as claimed in claim 10 wherein the arc detection subcircuit comprises a second silicon controlled rectifier (SCR) for detecting the presence of an arcing condition between the other of the lines and the metal sheath, the second SCR setting the circuit opening device at its second state upon detecting the presence of an arcing condition between the other of said lines and the metal sheath.

12. The fireguard circuit as claimed in claim 11 further comprising an indicator circuit connected to the power and neutral lines at the load, the indicator circuit providing an indication as to whether power is being applied to the load.

13. The fireguard circuit as claimed in claim 12 further comprising a test circuit connected to the power line to test whether the fireguard circuit is functioning properly.

14. The fireguard circuit as claimed in claim 1 wherein the power cable additionally includes a ground line which is electrically isolated from the power line and the neutral line.
